(19) United States
(12) Patent Application Publication
(10) Pub. No.: US 2022/0205171 A1
(43) Pub. Date: Jun. 30, 2022

(54) WATERPROOF, MOISTURE-PERMEABLE COMPOSITE NON-WOVEN FABRIC ABLE TO BLOCK VIRUSES AND BLOOD

(71) Applicant: Web-Pro Corporation, Kaohsiung City (TW)

(72) Inventors: Fu-Chun LIN, Kaohsiung City (TW); Ping-Sen LIAO, Kaohsiung City (TW); Ya-Tong CAI, Kaohsiung City (TW); Tsung-Chia WANG, Kaohsiung City (TW); Chiu-Ti WANG, Kaohsiung City (TW)

(21) Appl. No.: 17/136,908

(22) Filed: Dec. 29, 2020

(51) Int. Cl. D06N 3/14; D04H 13/00; D06N 3/00; D04H 3/007; D04H 3/011; D04H 3/009; D04H 3/015

(52) U.S. Cl. CPC D06N 3/141; D04H 13/00; D06N 3/0011; D04H 3/007; D10B 2401/021; D04H 3/009; D04H 3/015; D10B 2401/13; D04H 3/011

(57) ABSTRACT

The present invention provides a waterproof, moisture-permeable composite non-woven fabric able to block viruses and blood, and consists of a non-woven fabric, which is provided with two surfaces and has a basic weight of ≤70 g/m²; and a multi-layer breathable membrane, which is at least a three-layer co-extruded membrane. The basic weight of the multi-layer breathable membrane lies between 5˜30 g/m² and is attached to one of the surfaces of the non-woven fabric. A powder in the multi-layer breathable membrane has a percentage by weight of 40˜60% and an extension ratio ≤300%. The present invention has characteristics including a synthetic blood permeability able to resist pressure of 2.0 psi sustainable for at least one minute, a Phi-X17 bacteriophage penetrability able to resist pressure of 2.0 psi sustainable for at least one minute, and a moisture capacity ≥1500 g/m²·24 hr.

### BACKGROUND OF THE INVENTION

### (a) Field of the Invention

The present invention relates to application development of a waterproof, moisture-permeable composite non-woven fabric able to block viruses and blood, which provides a waterproof moisture-permeable composite non-woven fabric for use in P3 grade (CNS (China National Standards) 14798) medical protective clothing with the functionality to block viruses, bacteria, contaminated blood, and infected saliva aerosol.

### (b) Description of the Prior Art

When an infectious disease epidemic breaks out, there is sudden increase in demand for medical care protective equipment within a short period, with the cost of medical care protective equipment accordingly rising. Moreover, nations worldwide begin to attach importance to problems of shortage in protective equipment, such as protective clothing, masks, etc., among which protective clothing must be provided with resilient membrane material with specifications including high barrier protection, moisture-penetrability, waterproofing, and lightness. And the European Union Standard EN 14126, United States AAMI (Association for the Advancement of Medical Instrumentation), and Taiwan CNS (China National Standards) have their standard specifications regarding protective clothing for use against viruses and bacterial epidemics. However, the breathability of traditional P3 grade (CNS 14798) medical protective clothing is inferior, and thus there is a need for further development.

Past single layer breathable membranes are unable to block viruses because of the short breathable paths of the holes in the membranes, and if the material thickness is increased to lengthen the breathable paths, it is still unable to achieve the requirement for high breathability. Because the prior art is unable to achieve maximized effectiveness, hence, the inferior wearer comfortability, protective clothing made from such materials cannot be worn for long periods of time. When an epidemic breaks out, the demand for protective clothing increases, and because medical personnel need to wear protective clothing for long periods of time, thus, a new generation of protective clothing that must maintain a definite protective effect and improve comfortability has become a subject of future development.

Prior Art using the application of breathable composite laminate materials include Taiwan Patent No. 089110815 that relates to an absorption member provided with a top piece, a rear piece, and an absorption core between the top piece and the rear piece. The rear piece contains a vapor permeable and an essentially liquid impermeable composite laminate material, which is composed of a spun-bonded non-woven fabric adhered to a vapor permeable, thermoplastic membrane. The non-woven fabric is mainly composed of a first layer fabricated from compatible fibers that can be used to bond a web and a second layer fabricated from some fiber additives and a thermoplastic membrane that are compatible with a bonding adhesive and some that are incompatible.

Another prior art that has carried out research on moisture-permeability membranes includes Taiwan Patent No. 102144782, which discloses a moisture-permeable membrane able to maintain breathability, moisture-permeability, mechanical strength, and practicability, as well as permeable tolerance. A breathable membrane of Taiwan Patent No. 102144782 contains a polyethylene resin component (A) having a melt wave crest temperature of 130˜150° C. and a polyethylene resin density of 0.940˜0.970 g/cm³, an inorganic filler material (B), and styrene-based elastomers (C). In addition, relative to the total 100 mass percent of the aforementioned polyethylene resin component (A) and the inorganic filler material (B), a resin component structure with the addition of 1˜20 mass percent of the aforementioned styrene-based elastomers (C) has an effusion area less than 5%.

As for the manufacturing method study of antimicrobial compound fabric in the prior Art, Taiwan Patent No. 105106057 discloses an antimicrobial compound fabric combined or adhered to a fabric material. The processed fabric material, which can serve as sterilization material or disinfection material, and also possesses wash durability and non-permeable characteristics. A staining solution used in the processing cycle is composed of one or a plurality of antimicrobial agents, and the processed fabric material undergoes a heat treatment step.

Furthermore, the prior art connected with blood and virus blocking composite fabric coating research includes Taiwan Patent No. 099118884, which discloses a composite fabric composed of a non-woven fabric, wherein a fully-calendered non-woven fabric of fusible fibers is preferred; and a single breathable polymer layer. At least one surface of the fabric has excellent breathability, good abrasion resistance, and provides protection against both blood and virus agents. The composite woven fabric is composed of a single coating layer on a fibrous base material fabric. The composite woven fabric is provided with a MVTR (Moisture Vapour Transmission Rate) of at least 1500 g/m²/day, and has also passed both the ASTM (American Society for Testing Materials) F1670 blood blockage test and the ASTM F1671 virus blockage test.

### SUMMARY OF THE INVENTION

A waterproof, moisture-permeable composite non-woven fabric able to block viruses and blood requires the provision of high moisture-permeability, and must further be provided with the function to prevent blood and virus penetration. In other words, the surfaces of a waterproof, moisture-permeable composite non-woven fabric able to block viruses and blood must be completely impervious, however, it must allow for air dissipation. A waterproof, moisture-permeable composite non-woven fabric able to block viruses and blood of the present invention comprises: a non-woven fabric, which is provided with two surfaces, and has a basic weight of ≤70 g/m²; and a multi-layer breathable membrane, which is at least a three-layer co-extruded membrane. The basic weight of the multi-layer breathable membrane lies between 5˜30 g/m² and is attached to one of the surfaces of the non-woven fabric. A powder in the multi-layer breathable membrane has a percentage by weight of 40˜60% and an extension ratio ≤300%. The present invention has characteristics including a synthetic blood permeability able to resist pressure of 2.0 psi sustainable for at least one minute, a Phi-X174 bacteriophage penetrability able to resist pressure of 2.0 psi sustainable for at least one minute, and a moisture capacity ≥1500 g/m²·24 hr. The average grain diameter of the powder in the multi-layer breathable membrane lies between 0.5˜3 μm, with calcium carbonate (CaCO₃) being used as the powder. The non-woven fabric is at least a hydro-acupuncture non-woven fabric, a needle-punched non-woven fabric, a spun-bonded non-woven fabric, and a melt-blown non-woven fabric. The fibre diameter of the non-woven fabric is 0.5˜40 μm, and the fibrous material of the non-woven fabric is at least a polyethylene, polypropylene, polyester, polyvinyl alcohol, rayon, cotton, and a polyurethane and styrene-ethylene)/butylene-styrene copolymer. The multi-layer breathable membrane is a three-layer co-extruded membrane, with the layers being in the ratio of 1:1:1, 1:2:1, 1:3:1, 1:4:1 or 1:5:1. The percentage by weight of the powder in the multi-layer breathable membrane is 40˜60%, and achieves a moisture capacity ≥1500 g/m²·24 hr (CNS (China National Standards) 12222). The basic weight of the embodiment lies between 40˜100 g/m², achieves a moisture capacity ≥1500 g/m²·24 hr (CNS 12222), With an average grain diameter of 2 μm for the powder in the multi-layer breathable membrane of the present invention, the moisture capacity thereof reaches ≥1500 g/m²·24 hr (CNS 12222).

Further, the surface of the multi-layer breathable membrane of another embodiment of the waterproof, moisture-permeable composite non-woven fabric able to block viruses and blood is coated with at least one layer of moisture-permeable waterproof coating, which enables achieving a moisture capacity ≥1500 g/m²·24 hr (CNS 12222) for the entire embodiment. The moisture-permeable waterproof coating uses at least one waterborne polyurethane and a solventborne polyurethane. The multi-layer breathable membrane of the present invention comprises at least a three-layer co-extruded membrane that enables achieving partial blockage or elongated breathable channels. Moreover, the multi-layer breathable membrane is attached to the surface of the non-woven fabric, and is thus essentially distinct and different from the prior art. Moreover, the originality, advancement, and practical effectiveness of the present invention are unmistakable.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 shows a cross-sectional structural schematic view of a waterproof, moisture-permeable composite non-woven fabric able to block viruses and blood of the present invention.

FIG. 2 shows a cross-sectional structural schematic view of another embodiment of the waterproof, moisture-permeable composite non-woven fabric able to block viruses and blood of the present invention.

### DETAILED DESCRIPTION OF THE PREFERRED EMBODIMENTS

The following description uses specific concrete examples to describe the embodiment modes of the present invention. Persons skilled in the related art can easily deduce other advantages and effects of the present invention from the content disclosed in the specification. The present invention can also use other different concrete embodiments to clarify its performance and applications. Each detail described in the specification can also be based on a different perspective and application, enabling various types of modifications and alterations to be carried out without deviating from the spirit of the present invention.

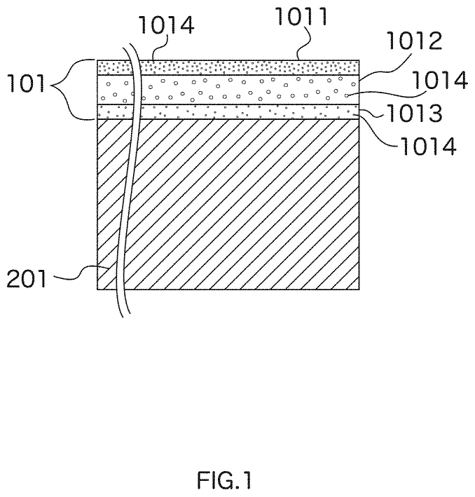

Referring first to FIG. 1, which shows a cross-sectional structural schematic view of a waterproof, moisture-permeable composite non-woven fabric able to block viruses and blood of the present invention, wherein an embodiment thereof comprises: a non-woven fabric 201, which is provided with two surfaces, and has a basic weight of ≤70 g/m²; and a multi-layer breathable membrane 101, which is at least a three-layer co-extruded membrane. The basic weight of the multi-layer breathable membrane 101 lies between 5˜30 g/m² and is attached to one of the surfaces of the non-woven fabric 201. A powder 1014 in the multi-layer breathable membrane 101 has a percentage by weight of 40˜60% and an extension ratio ≤300%. The embodiment of the present invention has characteristics including a synthetic blood permeability able to resist pressure of 2.0 psi sustainable for at least one minute, a Phi-X174 bacteriophage penetrability able to resist pressure of 2.0 psi sustainable for at least one minute, and a moisture capacity ≥1500 g/m²·24 hr. The average grain diameter of the powder 1014 in the multi-layer breathable membrane 101 lies between 0.5˜3 μm, with calcium carbonate (CaCO₃) being used as the powder 1014. The non-woven fabric 201 is at least a hydro-acupuncture non-woven fabric, a needle-punched non-woven fabric, a spun-bonded non-woven fabric, and a melt-blown non-woven fabric. The fibre diameter of the non-woven fabric 201 is 0.5˜40 μm, and the fibrous material of the non-woven fabric 201 is at least a polyethylene, polypropylene, polyester, polyvinyl alcohol, rayon, cotton, and a polyurethane and styrene-ethylene/butylene-styrene copolymer. The multi-layer breathable membrane 101 is a three-layer co-extruded membrane, with the layers being in the ratio of 1:1:1, 1:2:1, 1:3:1, 1:4:1 or 1:5:1. The percentage by weight of the powder 1014 in the multi-layer breathable membrane 101 is 40˜60%, and achieves a moisture capacity ≥1500 g/m²·24 hr (CNS (China National Standards) 12222). The basic weight of the embodiment lies between 40˜100 g/m², achieves a moisture capacity ≥1500 g/m²·24 hr (CNS 12222), water pressure resistance ≥140 cm H₂O, impact penetration ≤0.5 g (CNS 14801), vertical tensile strength ≥50N (ASTM (American Society for Testing Materials) D 5034), horizontal tensile strength ≥40N (ASTM D 5034), rupture strength ≥2000 kPa, stitch strength ≥40N, vertical tearing strength ≥20N (ASTM D 4533), horizontal tearing strength ≥20N (ASTM D 4533), test result for synthetic blood penetrability by pressure >13.8 kPa showed no penetration (CNS 14799), and test result for virus penetrability by pressure >13.8 kPa showed no penetration (CNS 14800). In other words, the waterproof, moisture-permeable composite non-woven fabric able to block viruses and blood has passed CNS 14798 China National Standards P3 grade tests. An impact penetration test method involved fixing a test sample to an experiment table at a 45 degrees angle, and a ladle-shaped container filled with 500 c.c. of water was made to impact the surface of the material at a distance of 0.6 meters from the experiment table, after which absorbent paper absorbed drops of water weighing ≤0.5 g on the reverse side. With an average grain diameter of 2 μm for the powder 1014 in the multi-layer breathable membrane 101 of the embodiment, the moisture capacity thereof reaches ≥1500 g/m²·24 hr (CNS 12222).

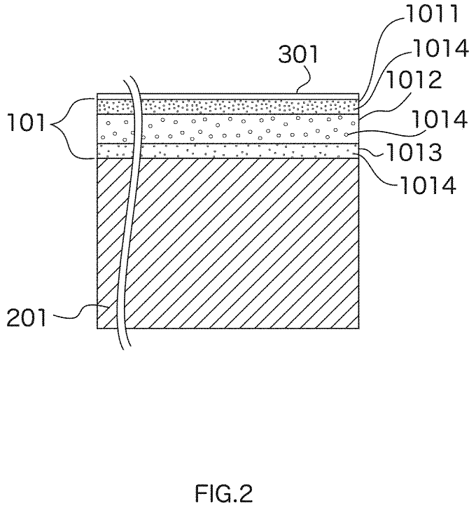

FIG. 2 shows a cross-section structural schematic view of another embodiment of the waterproof, moisture-permeable composite non-woven fabric able to block viruses and blood, wherein the surface of the multi-layer breathable membrane 101 thereof is coated with at least one layer of moisture-permeable waterproof coating 301, which enables achieving a moisture capacity ≥1500 g/m²·24 hr (CNS 12222) for the entire embodiment. The moisture-permeable waterproof coating 301 uses at least one waterborne polyurethane and a solventborne polyurethane. The thickness of the moisture-permeable waterproof coating 301 can be thinned down, which reduces material use for the moisture-permeable waterproof coating 301. The moisture-permeable waterproof coating 301 is provided with scratch resistance that prevents print on the surface thereof from coming off and assists in improving temperature resistance and dimensional stability thereof, which enables increasing the defect-free rate of ready-to-wear garments during the heat-sealing process. The moisture-permeable waterproof coating 301 adopts a smooth glossy surface structure or a matte surface structure to enable changing the visual effect of the embodiment of the present invention.

In order to enable the review committee to further understand that actual test results of the embodiment have shown that the present invention is provided with unexpected effectiveness, the inventors herein present a comparative example of a single layer breathable membrane attached to a non-woven fabric, comprising: the non-woven fabric 201, which is the same non-woven fabric 201 of the above-described embodiment, wherein the non-woven fabric 201 has two surfaces and a basic weight of ≤70 g/m². The single layer breathable membrane was an extruded membrane and had a basic weight that lied between 5˜30 g/m2. The single layer breathable membrane was attached to one of the surfaces of the non-woven fabric 201. and the powder 1014 in the single layer breathable membrane was the same powder 1014 of the above-described embodiment. The percentage by weight of the powder 1014 was 40˜60%, with an extension ratio ≤300%. The characteristics of the single layer breathable membrane attached to the non-woven fabric 201 include having a synthetic blood permeability able to resist pressure of 2.0 psi sustainable for at least one minute, a Phi-X174 bacteriophage penetrability able to resist pressure of 2.0 psi sustainable for at least one minute, with the test result for the Phi-X174 bacteriophage <1 PFU/ml; and a moisture capacity ≥1500 g/m²·24 hr. The average grain diameter of the powder 1014 in the single layer breathable membrane lied between 0.5˜3 μm, with calcium carbonate (CaCO₃) was used as the powder 1014. The non-woven fabric 201 was at least a hydro-acupuncture non-woven fabric, a needle-punched non-woven fabric, a spun-bonded non-woven fabric, and a melt-blown non-woven fabric. The fibre diameter of the non-woven fabric 201 was in the range of 0.5˜40 μm, and the preferred fibre diameter thereof was 2˜5 μm. The fibrous material of the non-woven fabric 201 was at least a polyethylene, polypropylene, polyester, polyvinyl alcohol, rayon, cotton, and a polyurethane and styrene-ethylene)/butylene-styrene copolymer. The percentage by weight of the powder 1014 in the single layer breathable membrane middle was 40˜60%, and achieved a moisture capacity ≥1500 g/m²·24 hr (CNS 12222). The basic weight of the comparative example of a single layer breathable membrane attached to the non-woven fabric 201 was 40˜100 g/m², and achieved a moisture capacity ≥1500 g/m²·24 hr (CNS 12222), the water pressure resistance ≥140 cm H₂O, impact penetration ≤0.5 g (CNS 14801), vertical tensile strength ≥50N (ASTM D 5034), horizontal tensile strength ≥40N (ASTM D 5034), rupture strength ≥2000 kPa, stitch strength ≥40N, vertical tearing strength ≥20N (ASTM D 4533), and horizontal tearing strength ≥20N (ASTM D 4533). With an average grain diameter of 2 μm for the powder 1014 in the single layer breathable membrane attached to the non-woven fabric 201; the moisture capacity thereof reaches ≥1500 g/m²·24 hr (CNS 12222) was achieved. The test result for synthetic blood penetrability by pressure >13.8 kPa on the comparative example showed no penetration (CNS 14799), however, the test result for virus penetrability by pressure >13.8 kPa showed penetration (CNS 14800). In other words, the single layer breathable membrane attached to the non-woven fabric 201 failed the CNS 14798 China National Standards P3 grade test.

In the embodiments and the comparative example described above in this specification, the multi-layer breathable membrane 101 of the present invention is provided with a virus-blocking effect, and primarily comprises a co-extruded three layer breathable membrane. Referring to FIG. 1, because the outermost layer first contacts bacteriophage suspension, thus, a first layer breathable membrane 1011 of the multi-layer breathable membrane 101 must have the effect to block the largest percent of bacteriophage suspension, and hence must be provided with the characteristics including a few apertures, a wide distribution of aperture sizes, and a relatively large membrane thickness, to bring into play the membrane surface density water repellent characteristic to enable blocking the suspension. However, because the calcium carbonate powder 1014 becomes moistened by the suspension, bacteriophage can still possibly diffuse and penetrate through a second layer breathable membrane 1012 of the multi-layer breathable membrane 101, hence, to intercept and minimize the concentration of the contacted bacteriophage, the degree of fineness of the layer of powder 1014 is maximized and the aperture sizes are kept to a minimum to prevent moisture penetration. In order for a third layer breathable membrane 1013 of the multi-layer breathable membrane 101 to block the penetration of all viruses, grain dimensions of the powder 1014 must be increased compared to the interception layers, while preventing forming continuous holes, only then can a complete blocking effect be achieved. Furthermore, the large aperture sizes and finely porous design of the inner layers enhances the moisture-permeable effect formed from the vapour pressure thereof, which improves wearing comfortability. The multi-layer breathable membrane 101 of the present invention uses the design specifications for the number of apertures, aperture sizes, and membrane thickness of each membrane layer to develop the highest grade protective waterproof, moisture-permeable composite non-woven fabric able to block viruses and blood.

The waterproof, moisture-permeable composite non-woven fabric able to block viruses and blood provided by the present invention not only has the characteristic to block blood and viruses, through the thickness design and the powder 1014 component between each of the layers, the multi-layer breathable membrane 101 is also able to bring a flow characteristic in each of the three layers thereof to achieve partial blockage or elongated breathable channels. The material components and manufacturing conditions fully disclosed in the above description provide the present invention with unexpected effectiveness in comparison with the comparative example, and is thus essentially distinct and different from the prior art. Moreover, the originality, advancement, and practical effectiveness of the present invention are unmistakable, and provide effective improvements on the shortcomings of the prior art, and thus has considerable practicability.

In conclusion, the concrete structures of the embodiments disclosed in the present invention effectively provide a protective fabric clothing application using a waterproof, moisture-permeable composite non-woven fabric able to block viruses and blood that has a blood and Phi-X174 bacteriophage penetrability able to resist a pressure of 2.0 psi sustainable for at least one minute, and a moisture capacity ≥1500 g/m²·24 hr. The specifications required to achieve the structures of the present invention are not achievable through easy assembly; furthermore, the overall structures are provided with the unexpected advantages of lightness and wearing comfortability, which have not been seen in like products or in any publications prior to this application, and thus clearly comply with the essential elements as required for a new patent. Accordingly, a patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A waterproof, moisture-permeable composite non-woven fabric able to block viruses and blood, comprising:
a non-woven fabric, which is provided with two surfaces, and has a basic weight of ≤70 g/m²;
a multi-layer breathable membrane, which is at least a three-layer co-extruded membrane, the basic weight of the multi-layer breathable membrane lies between 5˜30 g/m² and is attached to one of the surfaces of the non-woven fabric; a powder in the multi-layer breathable membrane has a percentage by weight of 40˜60% and an extension ratio ≤300%; wherein,
a synthetic blood permeability of the waterproof, moisture-permeable composite non-woven fabric able to block viruses and blood able to resist pressure of 2.0 psi sustainable for at least one minute;
a Phi-X174 bacteriophage penetrability of the waterproof, moisture-permeable composite non-woven fabric able to block viruses and blood able to resist pressure of 2.0 psi sustainable for at least one minute,
a moisture capacity of the waterproof, moisture-permeable composite non-woven fabric able to block viruses and blood ≥1500 g/m²·24 hr;
and the average grain diameter of the powder in the multi-layer breathable membrane lies between 0.5˜3 μm, with calcium carbonate (CaCO₃) being used as the powder.

2. The waterproof, moisture-permeable composite non-woven fabric able to block viruses and blood according to claim 1, wherein the non-woven fabric is at least a hydro-acupuncture non-woven fabric, a needle-punched non-woven fabric, a spun-bonded non-woven fabric, and a melt-blown non-woven fabric.

3. The waterproof, moisture-permeable composite non-woven fabric able to block viruses and blood according to claim 1, wherein the fibre diameter of the non-woven fabric is 0.5˜40 μm.

4. The waterproof, moisture-permeable composite non-woven fabric able to block viruses and blood according to claim 1, wherein the fibrous material of the non-woven fabric is at least a polyethylene, polypropylene, polyester, polyvinyl alcohol, rayon, cotton, and a polyurethane and styrene-ethylene/butylene-styrene copolymer.

5. The waterproof, moisture-permeable composite non-woven fabric able to block viruses and blood according to claim 1, wherein the multi-layer breathable membrane is a three-layer co-extruded membrane, with the layers being in the ratio of 1:1:1, 1:2:1, 1:3:1, 1:4:1 or 1:5:1.

6. The waterproof, moisture-permeable composite non-woven fabric able to block viruses and blood according to claim 1, wherein the percentage by weight of the powder in the multi-layer breathable membrane is 40˜60%, and achieves a moisture capacity ≥1500 g/m²·24 hr.

7. The waterproof, moisture-permeable composite non-woven fabric able to block viruses and blood according to claim 1, wherein the basic weight of the waterproof, moisture-permeable composite non-woven fabric able to block viruses and blood lies between 40˜100 g/m², and achieves a moisture capacity ≥1500 g/m²·24 hr.

8. The waterproof, moisture-permeable composite non-woven fabric able to block viruses and blood according to claim 1, wherein with an average grain diameter of 2 μm for the powder in the multi-layer breathable membrane, the moisture capacity thereof reaches ≥1500 g/m²·24 hr.

9. The waterproof, moisture-permeable composite non-woven fabric able to block viruses and blood according to claim 1, wherein the surface of the multi-layer breathable membrane of the waterproof, moisture-permeable composite non-woven fabric able to block viruses and blood is further coated with at least one layer of moisture-permeable waterproof coating, which enables achieving a moisture capacity ≥1500 g/m²·24 hr.

10. The waterproof, moisture-permeable composite non-woven fabric able to block viruses and blood according to claim 9, wherein the moisture-permeable waterproof coating uses at least one waterborne polyurethane and a solventborne polyurethane.
